(19) United States
(12) Patent Application Publication
(10) Pub. No.: US 2021/0354656 A1
(43) Pub. Date: Nov. 18, 2021

(54) FLAMELESS RETRACTOR PRETENSIONER ASSEMBLY

(71) Applicant: AUTOLIV ASP, INC., OGDEN, UT (US)

(72) Inventors: BIN WANG, LAKE ORION, MI (US); CHRISTOPHER D. HALL, ALGONAC, MI (US); JON BURROW, ORTONVILLE, MI (US); KEN KOHLNDORFER, ROSEVILLE, MI (US)

(73) Assignee: AUTOLIV ASP, INC., OGDEN, UT (US)

(21) Appl. No.: 16/875,698

(22) Filed: May 15, 2020

(51) Int. Cl. B60R 22/195

(52) U.S. Cl. CPC B60R 22/1955

(57) ABSTRACT

A seat belt pretensioner for use in a seat belt pretensioning retractor assembly includes a pretensioner tube in fluid communication with a gas generator, and a driving element with a piston disposed inside the pretensioner tube and formed a flexible elongated rod. At least a portion of an outer surface of the elongated rod spaced from an inside surface of the pretensioner tube defines at least one clearance space to be filled by the deformed elongated rod in the event that a gas pressure from the gas generator is applied to the piston when a sprocket is engaged with the elongated rod causing an overpressure condition in an actuation volume defined between the piston and the gas generator within the pretensioner tube.

### TECHNICAL FIELD

The present disclosure relates to a seatbelt restraint devices for restraining an occupant of a vehicle, and more particularly relates to devices for pretensioning a seatbelt.

### BACKGROUND

The statements in this section merely provide background information related to the present disclosure and may not constitute prior art.

Seatbelt restraint systems for restraining an occupant in a vehicle seat play an important role in reducing occupant injury in vehicle crash situations. In the seatbelt restraint systems, a belt retractor is typically provided to store belt webbing and may further act to manage belt tension loads in a crash situation. Seatbelt restraint systems which are manually deployed by the occupant (so-called “active” type) also typically include a buckle attached to the vehicle body structure by an anchorage. A latch plate attached to the belt webbing is received by the buckle to allow the belt system to be fastened for enabling restrain, and unfastened to allow entrance and egress from the vehicle. Accordingly, the seatbelt restrain systems, when deployed, effectively restrain the occupant during a collision.

OEM vehicle manufacturers often provide seatbelt restraint systems with pretensioning devices, which tension the seatbelt either during an impact of the vehicle or even prior to impact (also known as a “pretensioner”) to enhance occupant restraint performance. The pretensioner takes out slack in the webbing and permits the belt restraint system to couple with the occupant early in the crash sequence. One type of pretensioner acts on the webbing retractor to tension the belt.

Various designs of retractor pretensioners presently exist, including a type known as a roto-pretensioner that incorporates a gas generator using a pyrotechnic charge for generating inflation gas. Examples of such roto-pretensioners are described in U.S. Pat. No. 5,881,962, filed Apr. 11, 1995, U.S. Patent Application Publication No. 2006/0243843, filed Apr. 27, 2005, U.S. Patent Application Publication No. 2012/0006925, filed Jul. 6, 2010, and U.S. Pat. No. 7,988,084, filed Aug. 2, 2011, which are commonly owned by the assignee of the present application and are hereby incorporated by reference in their entirety for all purposes. Generally, ignition of the pyrotechnic charge or other combustible material creates gas pressure in a chamber having a piston to impart motion upon a driving element such as a piston, rack and pinion, or series of balls or a rod element disposed in a pretensioner tube, which engage with and wind a retractor spool pretensioner wheel to retract the webbing.

In a normal condition of the seatbelt pretensioning system, for example, the pretensioner is triggered when an occupant has loaded the seatbelt with a force higher than the pretensioning force. When triggered, the gas generator is activated and the piston starts to move by the generated gas inside the pretensioner tube. When the piston starts to travel, the chamber volume inside the pretensioner tube would grow, and the gas pressure in the chamber volume would drop. However, in an event that the pretensioning winding mechanism gets blocked, the chamber volume would not be able to increase so the gas pressure inside the chamber could be higher than the structural components, which are able to hold.

To mitigate the risk of over-pressured chamber, a permanent pressure relief valve (e.g., a small hole that is opened all the time) or a safety valve (e.g., in normal pretensioning events, the valve is closed, but the valve is able to open when the chamber is over-pressured) could be used to reduce the gas pressure inside the chamber. However, the hot and combustible gas released from the pretensioner could be a source for fire hazard or posts health risk if inhaled by the occupant.

Another method to mitigate the risk of over-pressured chamber is to use overload clutches. However, the overload clutches add weight and cost in the pretensioning system, and the packaging size may also have to increase in the pretensioner system.

### SUMMARY

The present disclosure relates to a seat belt pretensioner for use in a seat belt pretensioning retractor assembly. According to an aspect of the present disclosure, the seat belt pretensioner is generally rotopretensioner type and includes a pretensioner tube in fluid communication with a gas generator, a driving element with a piston disposed inside the pretensioner tube and adapted to travel within the pretensioner tube toward a sprocket in a housing upon an actuation of the gas generator to produce an actuation gas into an actuation volume bounded by the piston and the gas generator inside the pretensioner tube. In addition, the driving element in the form of a flexible elongated rod has a distal end portion disposed toward the sprocket and a proximal end portion disposed opposite the distal end portion, and is configured to extend in a longitudinal direction from the proximal end portion to the distal end portion. The seat belt pretensioner of the present disclosure includes features for accommodating so-called overpressure condition which can occur if the retractor sprocket becomes locked or otherwise the rotopretensioner sprocket does not rotate in a desired manner upon actuation of the pretensioner in the event of a detected vehicle impact or rollover condition. In an embodiment of the present disclosure, at least a portion of an outer surface of the elongated rod spaced from an inside surface of the pretensioner tube defines at least one clearance space. The elongated rod is configured to deform by compression between the proximal end portion and the distal end portion and fill in at least a portion of the clearance space in the event that gas pressure from the gas generator is applied to the piston when the sprocket is engaged with the elongated rod causing an overpressure condition in the actuation volume and the actuation volume expands due to deformation of the elongated rod (that is, the clearance space provides a volume for further expansion of the actuation gas) thereby reducing the gas pressure within the actuation volume to relieve the overpressure condition.

The reduced gas pressure within the actuation volume is configured to prevent the structure of the pretensioner tube from bursting.

According to a further aspect of the present disclosure, in the overpressure condition, a size of the actuation volume is increased by at least 15 percent due to the deformation of the elongated rod and the piston, and a traveled distance of the elongated rod in the overpressure condition. The increased size of the actuation volume reduces the gas pressure within the actuation volume to relieve the overpressure condition.

The portion of the outer surface of the elongated rod is formed having at least one recess for defining the clearance space. A recessed portion defining the recess extends generally in the longitudinal direction along the outer surface on a first side of the elongated rod. A recessed section extends along the outer surface in the longitudinal direction on a second side opposite the recessed portion.

According to an aspect of the present disclosure, the portion of the outer surface of the elongated rod is formed having at least one annular groove having a radial depth for defining the clearance space. The at least one annular groove is disposed at the proximal end portion of the elongated rod. The two or more annular grooves spaced along the longitudinal direction are disposed generally in an entire length of the elongated rod.

According to an aspect of the present disclosure, the portion of the outer surface of the elongated rod is formed having at least one longitudinal groove by extending along the longitudinal direction for defining the clearance space. Two or more longitudinal grooves are equally spaced along a circumferential direction of the elongated rod.

The elongated rod further includes a distal-most end having a chamfer disposed on a first side of the elongated rod and tapered inwardly along a length of the distal-most end in the longitudinal direction. In addition, the driving element is made from a polymer material.

In the overpressure condition, the expandable piston is operable to retain a high pressure as well as maintain the gas pressure within the actuation volume.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a plan view of a seatbelt retractor assembly including a pretensioner system in accordance with an exemplary form of the present disclosure;

FIG. 2 is an exploded view of the seatbelt retractor assembly including the pretensioner system of FIG. 1;

FIG. 3 is a sectional view of a pretensioner tube including the pretensioner system before an actuation of a gas generator, taken along line A-A in FIG. 1;

FIG. 4 is a sectional view of a pretensioner tube including the pretensioner system after the actuation of the gas generator, taken along line A-A in FIG. 1;

FIG. 5A is a plan view of an elongated rod in the pretensioner system of FIG. 2, and FIG. 5B is a cross-sectional view of the elongated rod, taken along line 5a -5a in FIG. 5A with the pretensioner tube;

FIG. 6A is a plan view of an elongated rod in accordance with an exemplary form of the present disclosure, and FIG. 6B is a cross-sectional view of the elongated rod, taken along line 6a -6a in FIG. 6A with the pretensioner tube;

FIG. 7A is a plan view of an elongated rod in accordance with an exemplary form of the present disclosure, and FIG. 7B is a cross-sectional view of the elongated rod, taken along line 7a -7a in FIG. 7A with the pretensioner tube;

FIG. 8A is a plan view of an elongated rod in accordance with an exemplary form of the present disclosure, and FIG. 8B is a cross-sectional view of the elongated rod, taken along line 8a -8a in FIG. 8A with the pretensioner tube; and

FIG. 9A is a plan view of an elongated rod in accordance with an exemplary form of the present disclosure, and FIG. 9B is a cross-sectional view of the elongated rod, taken along line 9a -9a in FIG. 9A with the pretensioner tube.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

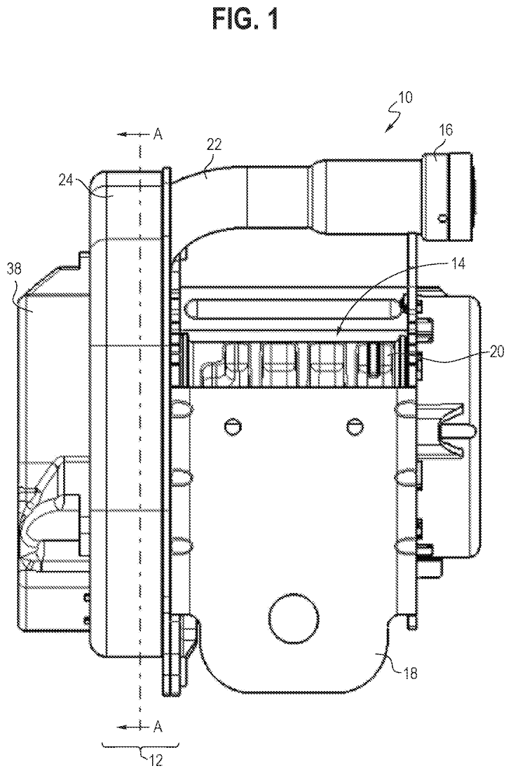

With reference to FIG. 1, a portion of the components of a retractor assembly 10 is illustrated. The retractor assembly 10 includes a seatbelt pretensioner 12, a spool assembly 14, and a gas generator 16 mounted to a common frame 18. The spool assembly 14 is connected with and stows a webbing of the shoulder belt portion (not illustrated), whereas the end of the lap belt portion of the webbing is fixedly engaged with the anchorage point of the vehicle (not illustrated). As shown in FIG. 1, the spool assembly 14 includes a spindle 20 that engages the shoulder belt portion of the seatbelt webbing and rotates to wind-up or pay-out the seatbelt webbing (not illustrated).

During normal operation of the vehicle, the retractor assembly 10 allows pay-out of the seatbelt webbing to give the occupant a certain amount of freedom of movement. However, if an impact or a potential impact situation is detected, the retractor assembly 10 is locked to prevent pay-out and to secure the occupant in the seat. For example, if the vehicle decelerates at a predetermined rate, then the retractor assembly 10 is locked. Due in part to the free pay-out of the seatbelt webbing, the seatbelt assembly often develops slack during normal use.

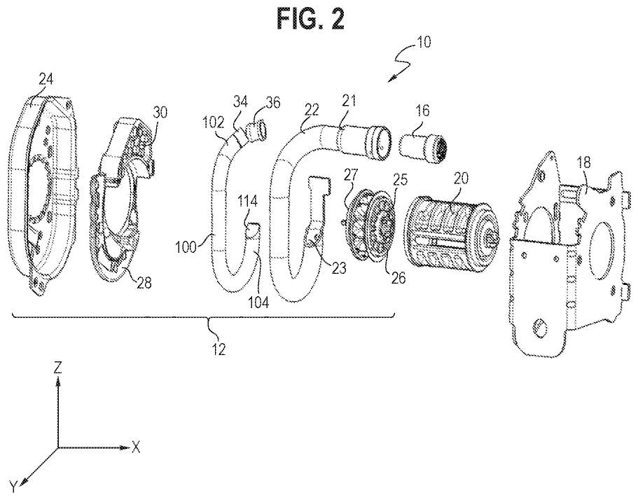

Referring to FIG. 2, an exploded view of certain components of the retractor assembly 10 is illustrated. In accordance with an exemplary form of the present disclosure, the retractor assembly 10 incorporates the seatbelt pretensioner 12 operatively connected to the spool assembly 14 and operable to rotate the spindle 20 for pretensioning. As known to those of skill in the art, a retractor pretensioner winds the seatbelt webbing into a more tight condition against the occupant at the initial stages of a detected vehicle impact. This is provided to reduce forward motion or excursion of the occupant in response to the deceleration forces of a vehicle impact or rollover.

As shown in FIGS. 1 and 2, the seatbelt pretensioner 12 includes a pretensioner tube 22 in communication with the gas generator 16 at a first tube end 21 of the pretensioner tube 22. The gas generator 16 is used to provide expanding gas in response to a firing signal. As known in the art, for example, the vehicle includes a sensor array sending a signal indicative of an emergency event such as an impact event, crash, or rollover. The vehicle sensor may be a specific impact sensor, or may be a traditional vehicle sensor (e.g., longitudinal or lateral acceleration sensor or otherwise part of a control system having a suite of multiple sensors). Any other impact sensor that is or will be known to those skilled in the art may also be readily employed in conjunction with the seatbelt assembly (not illustrated). An electronic control unit such as a central processing unit (CPU) or other controller receives a signal and controls the seatbelt assembly to respond by tightening the seatbelt webbing of the vehicle (e.g., via activation of a seatbelt pretensioner).

In FIG. 2, the pretensioner tube 22 has a driving element 100, e.g., an elongated rod or a plastically deformable polymer rod disposed therein that has an elongate shape and is flexible within the tube 22. More specifically and as will be discussed in further detail below, the elongated rod 100, when disposed outside of the pretensioner tube 22 prior to insertion therein, has a generally straight shape, and when inserted into the tube 22, it will bend and flex in accordance with the tortuous shape of the tube 22 as shown in the exploded view of FIG. 2.

As shown in FIGS. 1 and 2, the retractor assembly 10 includes the spool assembly 14 mounted to the common frame 18. More particularly, the spool assembly 14 will rotate relative to the common frame 18 to wind the seatbelt webbing attached to the spool assembly 14. The common frame 18 includes a housing 24 for placing the components of the seatbelt pretensioner 12 inside the housing 24. In addition, the seatbelt pretensioner 12 includes a sprocket 26 disposed within the housing 24 and attached to the spindle 20. Rotation of the sprocket 26 will cause the attached spindle 20 to rotate to wind the seatbelt webbing that is attached to the spindle 20.

In FIG. 2, the seatbelt pretensioner 12 further includes a guide plate 28, which is placed inside the housing 24. The guide plate 28 includes a guide portion 30 disposed within the housing 24 similar to the sprocket 26. The guide portion 30 having a generally arcuate landing surface 32 is disposed opposite an exit end 23 of the tube 22, and the sprocket 26 is disposed between the guide portion 30 and the tube 22. Accordingly, the elongated rod 100 exiting the tube 22 will contact the sprocket 26 prior to contacting the landing surface 32 of the guide portion 30.

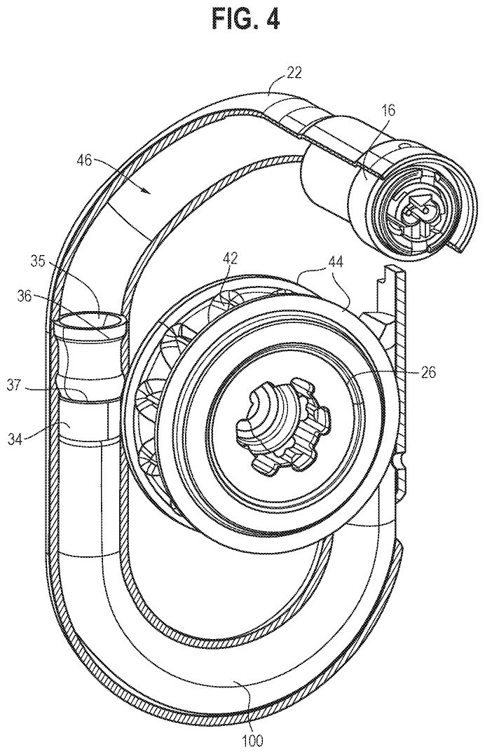

As described above, the seatbelt pretensioner 12 includes the sprocket 26 having a body portion 40 with a general annular shape. The sprocket 26 is configured to rotationally couple with the spindle 20 for operatively connecting the sprocket 26 to the spindle 20 at one side 25, and configured to operatively engage with a spring end cap 38 at the other side 27. As shown in FIGS. 2 and 4, the sprocket 26 includes a plurality of vanes 42 that each projects radially from the body portion 40. Furthermore, as shown in FIG. 4, the sprocket 26 further includes flanges 44 for guiding the elongated rod 100 when the rod 100 is engaged with the plurality of vanes 42 of the sprocket 26. The flanges 44 of the sprocket 26 radially extends further from the body portion 40 at both sides 25 and 27. Accordingly, the vanes 42 are extended between the pair of flanges 44 along radials extending from a central axis X of rotation of the body portion 40. (See FIG. 2). In addition, the flanges 44 of the sprocket 26 prevent the engaged rod 100 with the vanes 42 of the sprocket 26 from being laterally disengaged.

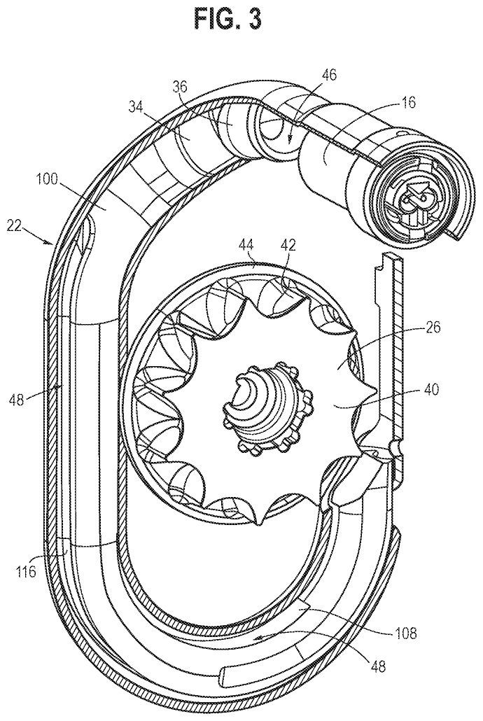

FIGS. 3 and 4 illustrate the elongated rod 100 with a stopper 34 inside the pretensioner tube 22 before engaging with the sprocket 26 and after engaging with the sprocket 26. The stopper 34 is sized to couple with the proximal end portion 102 of the elongated rod 100. The stopper 34 is fixedly attached to the proximal end portion 102 of the elongated rod 100 by an interference fit (e.g., a compression fit), an adhesive, or mechanical means. The stopper 34 is preferably made from aluminum, but could be made from another suitable material of sufficient strength, such as steel, other metal or metal alloy, or reinforced plastic. The stopper 34 has an outer perimeter that substantially matches the perimeter of the proximal end portion 102 of the elongated rod 100.

FIGS. 3 and 4 further illustrate a seal member such as a piston 36. The piston 36 can have a cylindrical shape with a generally cylindrical outer surface in an approach. In another approach, the piston 36 can have a spherical shape with a generally spherical outer surface for sealing. The piston 36 defines a generally elastic structure, and may be composed of various materials known in the art, such as any suitable plastic or polymer (e.g., polyester, rubber, thermoplastic, or other elastic or deformable material). Moreover, the piston 36 may be die cast, forged, or molded from metal, plastic, or other suitable material. The generally elastic structure allows the shape of the piston 36 to change slightly in response to pressure, thereby improving the sealing that it provides. The piston 36 is slidably disposed within the tube 22 and is operable to drive the elongated rod 100 along actuating direction. The piston 36 is press-fitted or otherwise fitted inside the tube 22. As shown in FIGS. 3 and 4, the piston 36 defines a proximal end 35 adjacent to and/or spaced from the gas generator 16, and a distal end 37 directed toward the stopper 34 and the elongated rod 100.

As shown in FIGS. 3 and 4, the retractor assembly 10 includes the gas generator 16 that provides expanding gas in response to a firing signal. The expanding gas causes an increase in pressure within the tube 22, which ultimately causes the elongated rod 100 to be forced away from the gas generator 16 and through the tube 22. The stopper 34 and the piston 36 cooperate to transfer the energy from the increased pressure in a gas chamber 46 defined as a space between the piston 36 and the gas generator 16 within the pretensioner tube 22 to the elongated rod 100. Activation of the gas generator 16 enables the piston 36 to forcibly drive the elongated rod 100 and causes the piston 36 to expand, which helps prevent gas from escaping past the piston 36. In addition, the piston 36 is operable to retain a high seal pressure as well as maintain residual gas pressure within the tube 22.

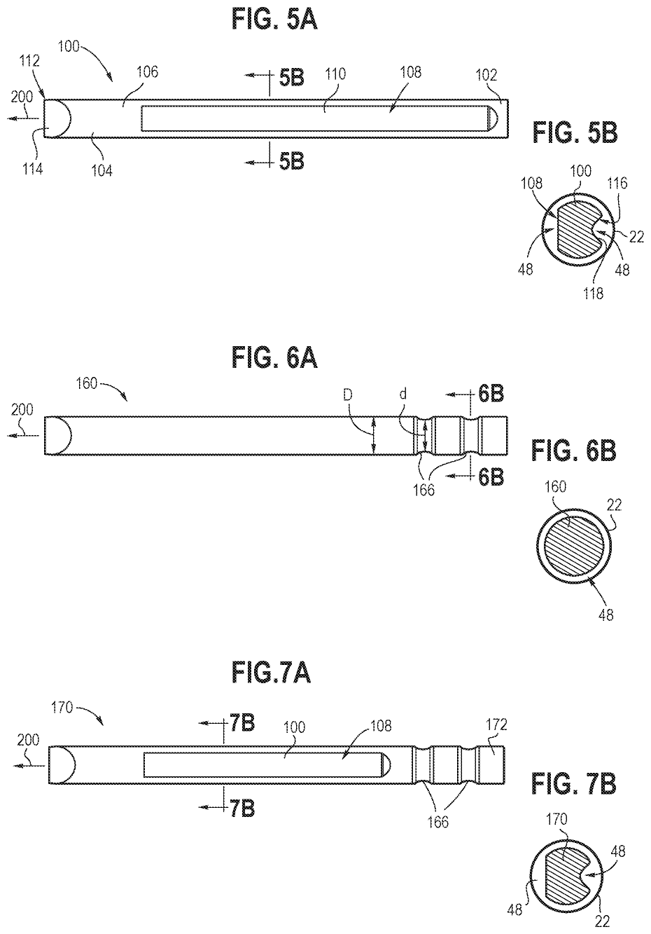

Referring to FIGS. 5A and 5B, the elongated rod 100 has a generally circular cross-section in accordance with an exemplary form of the present disclosure. According to other exemplary forms, the elongated rod 100 could have a non-circular cross-section, such as a rectangular cross-section, triangular cross-section, or other polygonal cross-section that allows the rod 100 to be inserted into the pretensioner tube 22 and adapt to the tortuous shape of the tube 22 when inserted. In addition, the polygonal cross-section may rotate along the length of the rod 100 to create a spiral shape.

As shown in FIG. 5A, the elongated rod 100, when disposed outside of the pretensioner tube 22, has a generally straight shape and extends in a longitudinal direction 200 from a proximal end portion 102 to a distal end portion 104. The proximal end portion 102 is disposed towards the gas generator 16 when the elongated rod 100 is installed within the seatbelt pretensioner 12. For example, in FIGS. 5A and 5B, the elongated rod 100 has a cross-section that varies along its length to define a non-recessed portion 106 and a recessed portion 108 that defines a recess (a first recess) 110. As shown in FIG. 5A, the recessed portion 108 extends along a majority of the overall length of the elongated rod 100 from the proximal end portion 102 to the distal end portion 104. Furthermore, the distal end portion 104 includes the non-recessed portion 106. Accordingly, the extended recess 110 from the proximal end portion 102 terminates at a distance spaced from a distal-most end 112.

In FIG. 5A, the elongated rod 100 further includes one or more chamfers 114 at the distal-most end 112 that taper inwardly along a length of the distal-most end 112 in the longitudinal direction 200. For example, the chamfer 114 is disposed on a same side (a first side) of the elongated rod 100 as the recess 110 is located. The chamfer 114 reduces the bending stiffness of the rod and advantageously reduces the force required to advance the elongated rod 100 in the pretensioner tube 22 to facilitate installation of the elongated rod 100 in the seatbelt pretensioner 12, and also increases an initial pretensioning force that can be transferred to the sprocket 26 due to the larger cross-section area of the chamfer 114. The chamfer 114 is formed as a concave shape with a curvature. The concave shape of the chamfer 114 is configured to better engage with the sprocket 26 during pretensioning because the concave shape of the chamfer 114 is formed along a circumference of the sprocket 26.

As shown in FIGS. 5A and 5B, the elongated rod 100 includes a recessed section 116 to further facilitate bending and preventing or minimizing twisting of the elongated rod 100 through the tube 22 during translating towards the sprocket 26. In particular, on a side (a second side) opposite the recess 110 of the elongated rod 100, the recessed section 116 defines a recess (a second recess) 118 and extends in the longitudinal direction 200. The recessed section 116 extends along the majority of the overall length of the elongated rod 100. In FIG. 5B, according to an exemplary form of the present disclosure, when the elongated rod 100 is disposed outside of the pretensioner tube 22, the recessed section 116 has a substantially flat, planar surface defining the second recess 118.

The elongated rod 100 is preferably made from a polymer material, which has a reduced weight relative to metallic ball driving elements used in the other rotopretensioners. The particular polymer material can be selected to fit the particular desires of the user. The polymer material is preferably one that has sufficient flexibility such that it can bend and flex through the pretensioner tube 22 to allow for initial installation as well as in response to actuation by the gas generator 16. The polymer material is preferably one that has sufficient stiffness to allow it to be pushed through the tube 22 in response to actuation, such that the rod 100 will sufficiently transfer a load to the sprocket 26 of the seatbelt pretensioner 12.

Further, the elongated rod 100 is preferably made from a polymer material that is deformable. During and after actuation, the elongated rod 100 will be deformed in response to actuation and contact with other components of the seatbelt pretensioner 12. Accordingly, due to the vanes 42 of the sprocket 26, the elongated rod 100 is dented (elastically and plastically deformed) without any material separation of the rod 100, so that the load exerted by the actuation gas pressure of the pretensioner 12 is fully transferred to the sprocket 26 through the deformation of the elongated rod 100. The plastic deformation will cause the pretensioner 12 become locked to prevent or limit payback of the rod 100 without being completely dependent on maintained actuation gas pressure in the system. The plastic deformation also allows the rod 100 to deform and engage with the vanes 42 of the sprocket 26. In one approach, the elongated rod 100 is made from a nylon thermoplastic material. The rod 100 could also be made from an aliphatic polyamide thermoplastic material. In another approach, the rod 100 could be made from a similar thermoplastic material, such as an acetal material or polyprophylene material.

In FIG. 4, as the elongated rod 100 is driven through the tube 22, it engages the sprocket 26. More particularly, engagement of the elongated rod 100 with the sprocket 26 causes the spindle 20 (shown in FIG. 2) to rotate, which in turn provides pretensioning. Activation of the gas generator 16 enables the piston 36 to resist gas leakage. As previously mentioned, the pressurized gas within the gas chamber 46 (called as an actuation volume) causes the proximal end 35 of the piston 36 to expand, which helps prevent gas from escaping past the piston 36 because the piston 36 is composed of a relatively elastic material.

In normal operation of the seatbelt pretensioner 12, backpressure generated from the elongated rod 100 causes the piston 36 to expand circumferentially outward due to compression of the piston 36 against the stopper 34 and the elongated rod 100. The elongated rod 100 undergoes resistance as it engages the sprocket 26 during actuation, thereby generating backpressure on the stopper 34 and the piston 36. The circumferential expansion of the piston 36 provides a tightened seal between the outer surface of the piston 36 and the inside surface of the pretensioner tube 22. Accordingly, the piston 36 of the present disclosure is operable to retain a relatively high seal pressure as well as maintain residual gas pressure within the tube 22.

During pretensioning of the seat belt in a flameless retractor pretensioner assembly 10, however, an overpressure condition inside the pretensioner tube 22 can occur. For example, The overpressure condition can be occurred when the spindle 20 of the retractor assembly 10 for some reason cannot pretension and the driving elements such as the elongated rod 100 experience substantial resistance as they attempt to advance toward an end of the pretensioning stroke (i.e., the pretensioning winding mechanism including the sprocket gets blocked or stalled, but is not failed or separated). This can cause a substantial increase in the pressure of the actuation gas from the gas generator that is advancing to expand and push the driving elements. During pretensioning in the flameless retractor assembly 10, accordingly, the pressure of the actuation gas inside the gas chamber 46 (the actuation volume) bounded by the piston 36 and the gas generator 16 within the pretensioner tube 22 is increased.

In the overpressure condition of the flameless retractor assembly 10, as described above, the present disclosure provides a self-pressure relief feature designed for a fully sealed pretensioning system due to the circumferentially expanded piston 36. In this condition, according to a form of the present disclosure, the elongated rod 100 in FIGS. 5A and 5B is configured to deform by compression between the proximal end portion 102 and the distal end portion 104. In FIGS. 3 and 4, when the flexible elongated rod 100 is disposed inside the pretension tube 22, at least one clearance space 48 is defined in at least a portion of the elongated rod 100 spaced from the inside surface of the pretensioner tube 22. For example, in FIGS. 5A and 5B, at least two clearance spaces 48 in each of the recessed portion 108 and the recess section 116 formed on the elongated rod 100 are defined. Accordingly, the clearance spaces 48 formed between the elongated rod 100 and the pretensioner tube 22 allows the gas chamber 46 to extend to larger volume in the overpressure condition because the elongated rod 100 is deformed and filled in the clearance spaces 48. In the overpressure condition, for example, the size of the actuation volume 46 is increased by at least 15 percent due to the deformation of the elongated rod 100 and the piston 36, and the travel of the elongated rod 100 until the elongated rod 100 gets blocked (or the minimum rod travel allowed by the structure of the retractor assembly 10).

The deformed elongated rod 100 is filled in a portion of the clearance spaces 48 so that the actuation volume (the gas chamber 46) between the piston 36 and the gas generator 16 is expanded thereby reducing the gas pressure within the actuation volume to relieve the overpressure condition. Accordingly, the self-pressure relief feature of the present disclosure provides the pretensioner safety margin for structural integrity and also retains the lower pressure hot gas in the gas chamber 46 for the extended period of time to allow post-crash occupant evacuation and vehicle disposition. Due to the lower pressure gas inside the gas chamber 46, the self-pressure relief feature in the overpressure condition can maintain the pretensioner's structure integrity. Accordingly, the self-pressure relief feature including the portion of the clearance spaces 48 within the pretensioner tube 22 is configured to prevent the structure of the pretensioner tube 22 from bursting or breaking by the reduced gas pressure within the actuation volume.

FIGS. 6A through 9B illustrate various shapes on the outer surfaces of the elongated rod 100 such as annular grooves, recesses, or longitudinal grooves, etc. for having at least one clearance space 48 spaced from the inside surface of the pretensioner tube 22.

In accordance with a form of the present disclosure, FIGS. 6A and 6B show an elongated rod 160 formed at least one annular groove 166 on the outer surface of the elongated rod 160 along a circumferential direction of the rod 160. The annular groove 166 is formed with a radial depth so that the diameter d of the annular groove 166 is smaller than the diameter D on the original outer surface of the elongated rod 100. For example, in FIG. 6A, two annular grooves 166 are formed on the proximal end portion 162 of the elongated rod 160 so that two clearance spaces 48 are defined between the elongated rod 160 and the inside surface of the pretensioner tube 22 due to the radial depth formed on the outer surface of the elongated rod 100. As described above, the clearance spaces 48 are filled by the deformed elongated rod 160 in the overpressure condition when the engaged rod 160 with the sprocket 26 gets blocked.

In accordance with a form of the present disclosure, FIGS. 7A and 7B show an elongated rod 170 formed to combine at least one annular groove 166 of the elongated rod 160 with the recessed portion 108 and/or the recessed section 116 of the elongated rod 100. For example, in FIG. 7A, more clearance spaces 48 are defined between the elongated rod 170 and the inside surface of the pretensioner tube 22 and the deformed elongated rod 170 are filled in the clearance spaces 48 in the overpressure condition as described above. As shown in FIG. 7A, in the elongated rod 170 having the annular grooves 166 on the proximal end portion 172, the length of each of the recessed portion 108 and the recessed section 116 on the outer surface of the elongated rod 170 is decreased along the longitudinal direction 200 of the elongated rod 170.

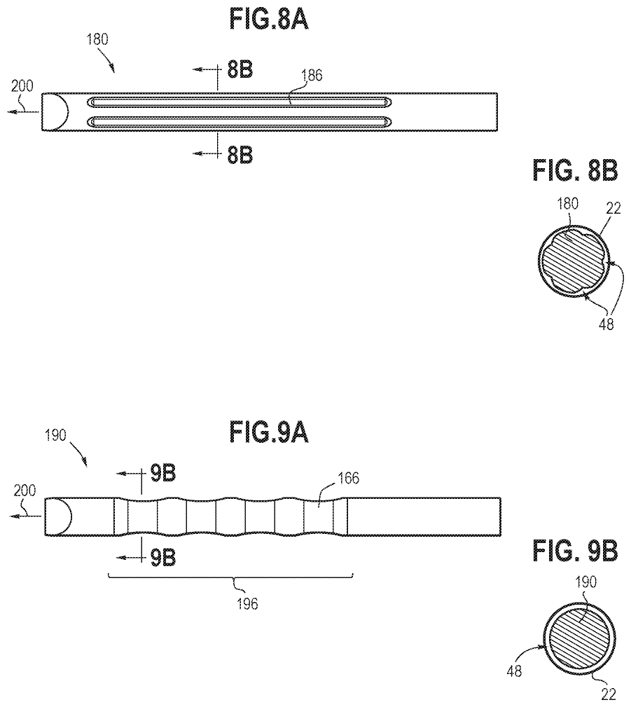

In accordance with a form of the present disclosure, FIGS. 8A and 8B show an elongated rod 180 formed at least one longitudinal groove 186 by extending along the longitudinal direction 200 of the rod 180. As shown in FIG. 8A, for example, the elongated rod 180 includes two or more longitudinal grooves 186 spaced along a circumferential direction of the elongated rod 180. Accordingly, as shown in FIG. 8B, the elongated rod 180 may be formed as fluted or a star shape in a cross-sectional view of the elongated rod 180. As described above, the clearance spaces 48 are defined between the elongated rod 180 and the inside surface of the pretensioner tube 22 so that the deformed elongated rod 180 is filled in the clearance spaces 48 formed by the longitudinal grooves 186 in the overpressure condition.

In accordance with a form of the present disclosure, FIGS. 9A and 9B show an elongated rod 190 formed as a wave shape 196 along the longitudinal direction 200 on an outer surface of the elongated rod 190. The wave shape 196 is formed to extend continuously with two or more annular grooves 166 having a radial depth along the entire length of the elongated rod 190. As described above, accordingly, the clearance spaces 48 are defined between the elongated rod 190 having the wave shape 196 and the inside surface of the pretensioner tube 22, and the deformed elongated rod 190 is filled in the clearance spaces 48 in the overpressure condition.

While the above description constitutes the preferred embodiments of the present invention, it will be appreciated that the invention is susceptible to modification, variation and change without departing from the proper scope and fair meaning of the accompanying claims.

What is claimed is:

1. A seat belt pretensioner for use in a seat belt pretensioning retractor assembly, the seat belt pretensioner comprising:
a pretensioner tube in fluid communication with a gas generator; a driving element with a piston disposed inside the pretensioner tube, the driving element adapted to travel within the pretensioner tube toward a sprocket in a housing upon an actuation of the gas generator to produce an actuation gas into an actuation volume bounded by the piston and the gas generator inside the pretensioner tube;
the driving element in the form of a flexible elongated rod having a distal end portion disposed toward the sprocket and a proximal end portion disposed opposite the distal end portion, the driving element configured to extend in a longitudinal direction from the proximal end portion to the distal end portion; and
at least a portion of an outer surface of the elongated rod spaced from an inside surface of the pretensioner tube defining at least one clearance space,
wherein the elongated rod is configured to deform by compression between the proximal end portion and the distal end portion and fill in at least a portion of the clearance space in an event that a gas pressure from the gas generator is applied to the piston when the sprocket is engaged with the elongated rod causing an overpressure condition in the actuation volume and the actuation volume expands due to deformation of the elongated rod thereby reducing the gas pressure within the actuation volume to relieve the overpressure condition.

2. The seat belt pretensioner of claim 1, wherein the reduced gas pressure within the actuation volume is configured to prevent a structure of the pretensioner tube from bursting.

3. The seat belt pretensioner of claim 1, wherein the portion of the outer surface of the elongated rod is formed having at least one recess for defining the clearance space.

4. The seat belt pretensioner of claim 3, wherein a recessed portion defining the recess extends generally in the longitudinal direction along the outer surface on a first side of the elongated rod.

5. The seat belt pretensioner of claim 4, wherein a recessed section extends along the outer surface in the longitudinal direction on a second side opposite the recessed portion.

6. The seat belt pretensioner of claim 1, wherein the portion of the outer surface of the elongated rod is formed having at least one annular groove having a radial depth for defining the clearance space.

7. The seat belt pretensioner of claim 6, wherein the at least one annular groove is disposed at the proximal end portion of the elongated rod.

8. The seat belt pretensioner of claim 6, wherein the two or more annular grooves spaced along the longitudinal direction are disposed generally in an entire length of the elongated rod.

9. The seat belt pretensioner of claim 1, wherein the portion of the outer surface of the elongated rod is formed having at least one longitudinal groove by extending along the longitudinal direction for defining the clearance space.

10. The seat belt pretensioner of claim 9, wherein the two or more longitudinal grooves are equally spaced along a circumferential direction of the elongated rod.

11. The seat belt pretensioner of claim 1, wherein the elongated rod further includes a distal-most end having a chamfer disposed on a first side of the elongated rod and tapering inwardly along a length of the distal-most end in the longitudinal direction.

12. The seat belt pretensioner of claim 1, wherein in the overpressure condition, the expandable piston is operable to retain a high seal pressure as well as maintain the gas pressure within the actuation volume.

13. The seat belt pretensioner of claim 1, wherein the driving element is made from a polymer material.

14. A seat belt pretensioner for use in a seat belt pretensioning retractor assembly, the seat belt pretensioner comprising:
a pretensioner tube in fluid communication with a gas generator;
a driving element with a piston disposed inside the pretensioner tube, the driving element adapted to travel within the pretensioner tube toward a sprocket in a housing upon an actuation of the gas generator to produce an actuation gas into an actuation volume bounded by the piston and the gas generator inside the pretensioner tube;
the driving element in the form of a flexible elongated rod having a distal end portion disposed toward the sprocket and a proximal end portion disposed opposite the distal end portion, the driving element configured to extend in a longitudinal direction from the proximal end portion to the distal end portion; and
at least a portion of an outer surface of the elongated rod spaced from an inside surface of the pretensioner tube defining at least one clearance space,
wherein the elongated rod is configured to deform by compression between the proximal end portion and the distal end portion and fill in at least a portion of the clearance space in an event that a gas pressure from the gas generator is applied to the piston when the sprocket is engaged with the elongated rod causing an overpressure condition in the actuation volume, and
wherein in the overpressure condition, a size of the actuation volume is increased by at least 15 percent.

15. The seat belt pretensioner of claim 14, wherein the increased size of the actuation volume reduces the gas pressure within the actuation volume to relieve the overpressure condition.

16. The seat belt pretensioner of claim 15, wherein the reduced gas pressure within the actuation volume is configured to prevent a structure of the pretensioner tube from bursting.

17. The seat belt pretensioner of claim 14, wherein the portion of the outer surface of the elongated rod is formed having at least one recess for defining the clearance space.

18. The seat belt pretensioner of claim 14, wherein the portion of the outer surface of the elongated rod is formed having at least one annular groove having a radial depth for defining the clearance space.

19. The seat belt pretensioner of claim 14, wherein the portion of the outer surface of the elongated rod is formed having at least one longitudinal groove by extending along the longitudinal direction for defining the clearance space.

20. The seat belt pretensioner of claim 14, wherein the size of the actuation volume is increased due to the deformation of the elongated rod and the piston, and a traveled distance of the elongated rod in the overpressure condition.
